(19) United States
(12) Patent Application Publication
(10) Pub. No.: US 2008/0264351 A1
(43) Pub. Date: Oct. 30, 2008

(54) Disposable pet garment

(76) Inventor: Walter Lee Williams, Los Angeles, CA (US)

Correspondence Address: Cislo & Thomas LLP, 1333 2nd Street, Suite #500, Santa Monica, CA, 90401-4110, US

(21) Appl. No.: 12/150,278

(22) Filed: Apr. 25, 2008

Related U.S. Application Data
(60) Provisional application No. 60/926,388, filed on Apr. 27, 2007.

(51) Int. Cl. A01K 13/00

(52) U.S. Cl. 119/850

(57) ABSTRACT

A one-piece pet garment having an anterior portion, a dorsal portion adjacent to the anterior portion, a ventral portion opposite the dorsal portion and adjacent to the anterior portion, and a posterior portion adjacent to the dorsal and the ventral portions and opposite the anterior portion, wherein the anterior portion comprises a head orifice, and a the ventral portion comprises a plurality of sleeves. The pet garment may be made of a biodegradable, disposable material or an elastic material. The pet garment may further comprise perforations for ventilation. The pet garment may be treated with a flea and tick repellant.

### CROSS-REFERENCE TO RELATED APPLICATION

This patent application claims the benefit of U.S. Provisional Patent Application Ser. No. 60/926,388, entitled “Pets Wear,” filed Apr. 27, 2007, which application is incorporated in its entirety here by this reference.

### TECHNICAL FIELD

This invention relates to garments for pets to reduce the spread of pet hair.

### BACKGROUND ART

Many pet owners love to take their beloved pets for car rides and visits to the houses of friends and family. During these trips, a pet's fur is prone to shedding and often collects on the upholstery of the automobile or on home furniture. Fur can be difficult to remove and for those with allergies, this inconvenience can also prove annoying.

In addition, pet owners, particularly owners of dogs, who treat their animals to outdoor hikes and runs must carefully comb the pet afterward to check for fleas and ticks. Even exposure to other animals with fleas and ticks will cause problems for the pet. Without proper preventative care, a pet can become a carrier of fleas and ticks, even if he does not venture into the woods.

Current pet garments either do not provide proper coverage of the pets body to effectively capture the fur, or the pet garment requires multiple parts to effectively cover the pet's body and require multiple, inconvenient fastening mechanisms. In addition, these garments are not disposable.

For flea and tick treatment, some pet garments only provide a thin strip within the pet garment. Such minimal coverage would limit the effectiveness of the treatment. In addition, inconvenient installation is required.

Thus, there is still a needed is an easy-to-use, comfortable, disposable pet garment that can effectively minimize the dispersal of pet hair or fur and provide effective treatment of fleas and ticks.

### SUMMARY OF THE INVENTION

The present invention is directed to a full body jumpsuit that is designed for daily wear by a pet. Preferably, the pet garment is worn when the pet is riding in a car, visiting the home of another, or relaxing on home furniture, as it will reduce fur from shedding and collecting in unwanted areas, such as clothes and furniture. The pet garment may also be worn outdoors to reduce the chances of the pet picking up fleas and ticks. Pet Wear is disposable and can be created in various sizes to suit any pet. In addition, the pet garment may be made breathable to reduce and potential of the pet overheating.

### BRIEF DESCRIPTION OF DRAWINGS

FIG. 1 is rear perspective view of an embodiment of the present invention;

FIG. 2 is a front perspective view of another embodiment of the present invention;

FIG. 3 is a rear perspective view of another embodiment of the present invention; and

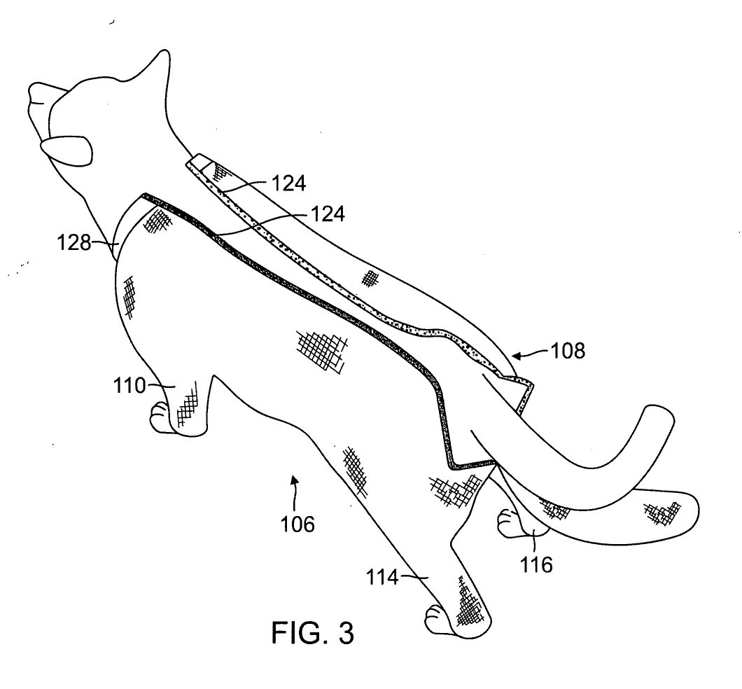

FIG. 4 is plan view an embodiment of the present invention laid open.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

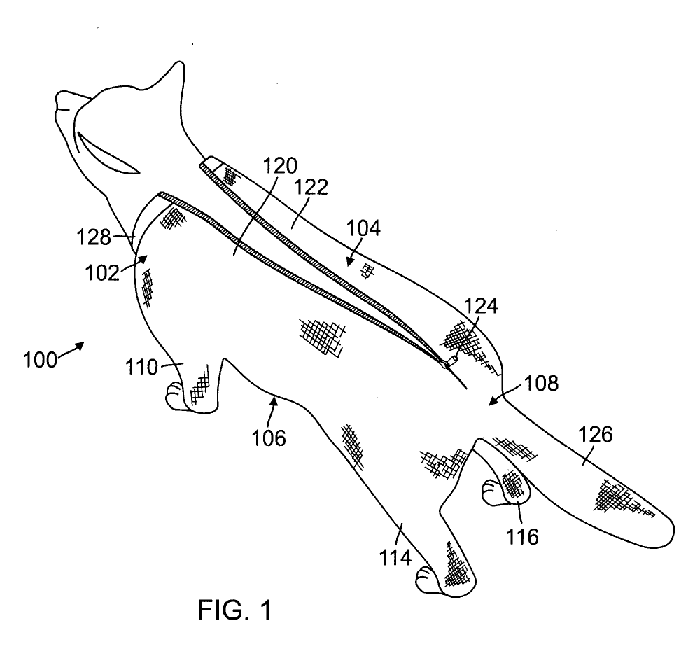

As shown in FIG. 1, the pet garment 100 is a one-piece product for reducing the spread of pet hair and treating and/or preventing flea and tick infestations, made to fit the entire body of a pet, leaving the head and paws exposed. The pet garment 100 has an anterior portion 102, a dorsal portion 104 adjacent to the anterior portion 102, a ventral portion 106 opposite the dorsal portion 104 and adjacent to the anterior portion 102, and a posterior portion 108 adjacent to the dorsal 104 and the ventral 106 portions and opposite the anterior portion 102, wherein the anterior portion 102 comprises a head orifice 110, and a the ventral portion 106 comprises a plurality of sleeves 110, 112, 114, 116.

In some embodiments, the dorsal portion 104 is split bilaterally forming two bilateral dorsal flaps 120, 122. The bilateral flaps 120, 122 allow the one-piece pet garment 100 to be opened to facilitate donning the one-piece garment 100 on a pet. The dorsal flaps 120, 122 comprise a first fastener 124 to fasten the dorsal flaps 120, 122 together to close the pet garment 100 after putting it on the pet. The first fastener 124 may be any number of quick-releasing fasteners, such as hook-and-loop fasteners, snap buttons, magnets, zippers, clips, adhesives, and the like. In some embodiments, the bilateral split along the dorsal portion 104 may extend towards the posterior portion 108 and down towards the ventral portion 106. Thus, the first fastener 124 may be opened at the ventral portion 106 to allow the pet to urinate or defecate.

In some embodiments, the dorsal portion 104 may not have any splits. In such embodiments, the pet garment may be at least partially made out of an elastic material or any combination of elastic material to facilitate donning the pet garment 100 onto a pet, for example, nylon, chloroprene (NEOPRENE), elastane (SPANDEX), and the like.

The ventral portion 106 comprises a plurality of sleeves 110, 112, 114, 116. The plurality of sleeves 110, 112, 114, 116 may be integrally constructed with the ventral portion 106, thereby making the pet garment 100 a single piece. In other words, the sleeves 110, 112, 114, 116 and the ventral portion 106 may be one continuous piece of material. Alternatively, the sleeves 110, 112, 114, 116 may be a separate piece of material but irreversibly attached to the ventral portion 106 so as to essentially be one integral piece. Irreversibly attached means attached in such a way as to prevent removal of the sleeves without cutting, ripping, or otherwise damaging the pet garment 100. In other words, the sleeves 110, 112, 114, 116 cannot be detached and reattached without significant effort. For example, the sleeves 110, 112, 114, 116 may be stitched or sewn on or may be attached by adhesives, such as glue.

Having a one-piece pet garment 100 reduces the number of pieces to the garment. This reduces the chance of losing any single piece of the garment. In addition, donning the garment is easier in that additional components do not have to be attached.

The one-piece garment 100 is generally designed for a four-legged pet that has a propensity for shedding hair, such as a dog and a cat. As such, the preferred embodiment has four sleeves 110, 112, 114, 116, two fore sleeves 110, 112 and two hind sleeves 114, 116. The sleeves 110, 112, 114, 116 may each have elastic cuffs 200, 202, 204, 206 for better fitting.

In some embodiments, the ventral portion 106 further comprises an excrement hole 400. The location of the excrement hole 400 varies depending on whether the garment 100 is a male version or a female version. For example, in the female version the excrement hole 400 may be at the posterior end just below the anus. In some embodiments, the excrement hole 400 may be large enough to be unisex. In other words, the excrement hole 400 may be an elongated opening extending from approximately midway between the fore leg sleeves 110, 112 and the hind leg sleeves 114, 116 towards the posterior end, just above the anus. The excrement hole 400 may be covered by an excrement flap 402. The excrement flap 402 may be fastened to the posterior portion 108 or dorsal portion 104 by a second fastener 404. The second fastener 404 may be any number of quick-releasing fasteners, such as hook-and-loop fasteners, snap buttons, magnets, zippers, clips, adhesives, and the like. The excrement flap 402 may further comprise a pull tab for easy opening of the flap by the owner. This allows the owner to open the flap and fasten the flap to the ventral portion 106 away from the genitals to allow the pet to urinate or defecate without obstruction or interference from the garment. When the pet is urinating or defecating the flap 402 can quickly and easily be detached from the ventral portion 106 of the garment and re-attached to the posterior or dorsal portion 104 or 108 to cover the excrement hole 400. In some embodiments, there may be two bilateral fasteners on the flap so that the flap may be fastened to the dorsal portion while the bilateral fasteners straddle the tail. The second fastener may also be any number of quick-releasing fasteners, such as hook-and-loop fasteners, snap buttons, magnets, zippers, clips, adhesives, and the like.

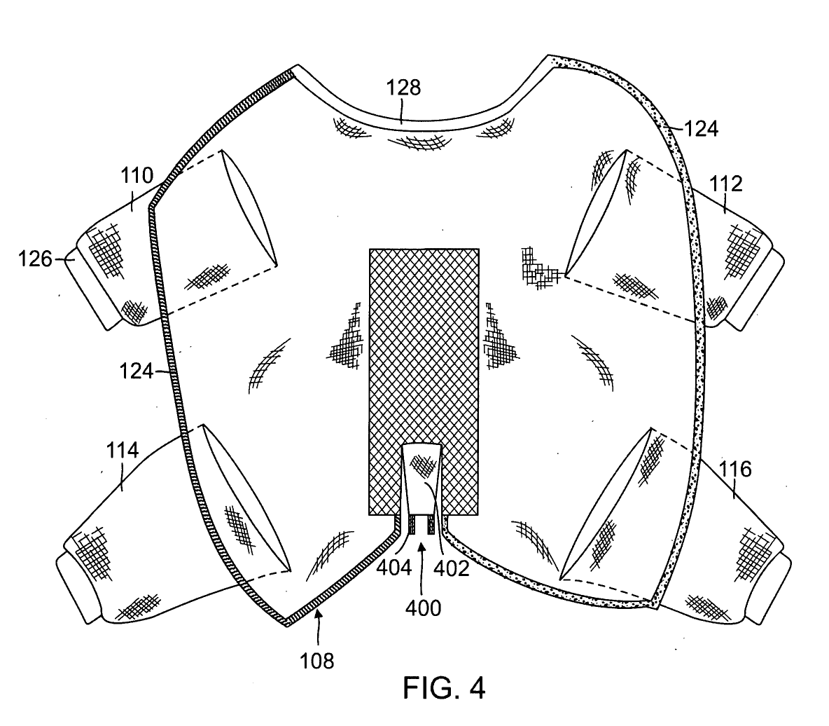

The ventral portion 106 may further comprise a ventilation means 200. Ventilation of the ventral side 106 may be conducted by several means. For example, the ventral portion may have perforations. In some embodiments, the ventral portion may be made of a breathable fabric 208 or material, such as nylon or mesh as shown in FIG. 4.

The posterior portion 108 may comprise a tail sleeve 126 to contain the tail of a pet. The tail sleeve 126 may be integrally formed with the pet garment 100. Thus, the tail sleeve 126 may be a continuation of the posterior portion 108 or the tail sleeve 126 may be irreversibly attached to the posterior portion 108. In some embodiments, the tail sleeve 126 may also be split bilaterally to facilitate insertion of the tail into the tail sleeve 126. The first fastener 124 can extend to the end of the tail sleeve. In other embodiments, the tail sleeve 126 may not contain any splits and the tail is simply inserted into the tail sleeve 126.

Unlike some pet garments, which leave substantial hairy portions of the pets body unenclosed (such as the legs or the belly), the present pet garment covers approximately 75% to 90% of the portions of the pet's body that can shed hair, thereby improving the effectiveness over prior art garments.

The pet garment 100 may be made out of any material that can contain hair without causing the pet to overheat. The pet garment is preferably made out of material that is elastic, breathable, disposable and/or biodegradable. A non-exhaustive list of example material includes nylon, mesh, polypropylene, cotton, paper, and any combination thereof.

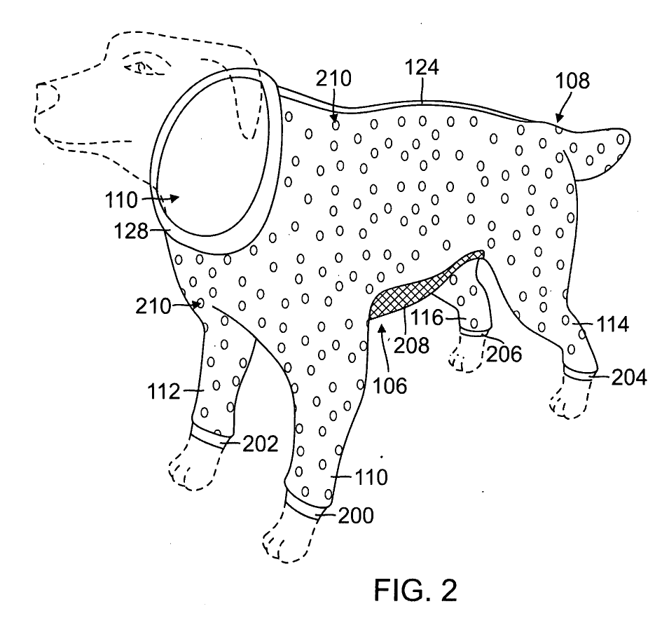

In some embodiments, the pet garment may comprise perforations 210 as shown in FIG. 2. When using material that is not very elastic, elastic material may be added to select regions such as the collar 128 and the cuffs of the sleeves 200, 202, 204, 206.

As such, in some embodiments, the pet garment may fit loosely, fit tightly, be at least partially elastic, be made of paper, be made of breathable material, be disposable, have perforations, have a mesh ventral portion, or any combination thereof. The pet garment 100 may further comprise decorative collars, may be made in a variety of colors, designs, patterns, and styles to suit male or female pets and can be created in sizes extra small, small, medium, large, and extra large.

The pet garment may also be treated with a flea and tick repellant. The pet garment may be pretreated with the flea and tick repellant prior to being sold, or the owner can treat the pet garment with any commercially available flea and tick treatment.

In use, a pet owner places each leg of his pet through the respective sleeve, one by one and pulls the pet garment 100 taut against the ventral surface of the pet. The user can then tuck the tail inside the tail sleeve 126, bring the two bilateral flaps 120, 122 together and secure the first fastener 124 along the spine or dorsal surface. In some embodiments, the first fastener 124 may extend towards the posterior portion 108 and down to the ventral portion 106. Thus, if a pet needs to urinate or defecate, only the ventral portion needs to be unfastened. Alternatively, the pet garment 100 may comprise an excrement flap 402 to provide a means to urinate or defecate without removing the pet garment 100 entirely.

In elastic embodiments without a bilateral split along the dorsal portion 104 of the pet garment 100, the pet garment 100 is rolled or scrunched up so that the hind sleeves 114, 116 are accessible through the head orifice 110. The hind legs are inserted through the head orifice and a sleeve, one at a time. Due to the elasticity, the head orifice 110 is able to stretch in directions allowing for such insertions. The pet garment 100 is unraveled and the head orifice 110 is raised up over the hind legs until the tail sleeve 126 is exposed. The tail is then inserted into the tail sleeve 126 and the pet garment 100 is unraveled more as the head orifice 110 is pulled up over the ventral and dorsal surface of the pet towards its head. By this time the forelimb sleeves 110, 112 are exposed and the forelimbs are inserted into the forelimb sleeves 110, 112. Once the forelimbs are inserted the pet garment is further unraveled until the head orifice 110 reaches the neck of the pet.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A pet garment for reducing the spread of pet hair, comprising:
a. an anterior portion;
b. a dorsal portion adjacent to the anterior portion, wherein the dorsal portion comprises a first fastener to close the pet garment;
c. a ventral portion opposite the dorsal portion and adjacent to the anterior portion; and
d. a posterior portion adjacent to the dorsal and the ventral portions and opposite the anterior portion;
e. a head orifice located at the anterior portion;
f. a plurality of sleeves protruding from the ventral portion, wherein the plurality of sleeves are integrally formed with the ventral portion; and
g. a tail sleeve protruding from the posterior portion.

2. The pet garment of claim 1, wherein the pet garment is made of a biodegradable, disposable material.

3. The pet garment of claim 2, further comprising perforations for ventilation.

4. The pet garment of claim 3, wherein the disposable material comprises paper.

5. The pet garment of claim 4, wherein the ventral portion comprises mesh.

6. The pet garment of claim 4, wherein the ventral surface further comprises an excrement flap, the excrement flap comprising a second fastener to secure the excrement flap in an open or closed configuration.

7. The pet garment of claim 4, wherein the plurality of sleeves each comprises an elastic cuff.

8. The pet garment of claim 4, wherein the pet garment is treated with a flea and tick repellant.

9. A pet garment for reducing the spread of pet hair, comprising:
a. an anterior portion;
b. a dorsal portion adjacent to the anterior portion, wherein the dorsal portion comprises a first fastener to close the pet garment;
c. a ventral portion opposite the dorsal portion and adjacent to the anterior portion; and
d. a posterior portion adjacent to the dorsal and the ventral portions and opposite the anterior portion;
e. a head orifice located at the anterior portion;
f. a plurality of sleeves protruding from the ventral portion, wherein the plurality of sleeves are integrally formed with the ventral portion; and
g. a tail sleeve protruding from the posterior portion, wherein the pet garment is made of an elastic material.

10. The pet garment of claim 9, wherein the elastic material is breathable.

11. The pet garment of claim 10, wherein the ventral surface further comprises an excrement flap, the excrement flap comprising a second fastener to secure the excrement flap in an open or closed configuration.

12. The pet garment of claim 11, wherein the ventral portion comprises a mesh material.

13. The pet garment of claim 11, wherein the pet garment is treated with a flea and tick repellant.

14. The pet garment of claim 9, further comprising perforations for ventilation.

15. The pet garment of claim 14, wherein the ventral surface further comprises an excrement flap, the excrement flap comprising a second fastener to secure the excrement flap in an open or closed configuration.

16. The pet garment of claim 15, wherein the ventral portion comprises a mesh material.

17. The pet garment of claim 15, wherein the pet garment is treated with a flea and tick repellant.

18. A pet garment for reducing the spread of pet hair, comprising:
a. an anterior portion;
b. a dorsal portion adjacent to the anterior portion, wherein the dorsal portion comprises a first fastener;
c. a ventral portion opposite the dorsal portion and adjacent to the anterior portion, wherein a segment of the ventral portion comprises a mesh fabric; and
d. a posterior portion adjacent to the dorsal and the ventral portions and opposite the anterior portion;
e. a head orifice located at the anterior portion;
f. a plurality of sleeves protruding from the ventral portion, wherein the plurality of sleeves are integrally formed with the ventral portion, wherein each sleeve comprises an elastic sleeve cuff;
g. a tail sleeve protruding from the posterior portion;
h. an excrement hole on the ventral portion;
i. an excrement flap connected to the ventral portion comprising a second fastener to secure the excrement flap in an opened or a closed configuration to uncover or cover the excrement hole; and
j. a plurality of perforations throughout the pet garment to provide ventilation for a pet, wherein the pet garment is substantially made of a biodegradable, disposable paper material and comprises a flea and tick repellant.
